(19) United States
(12) Patent Application Publication
(10) Pub. No.: US 2005/0164549 A1
(43) Pub. Date: Jul. 28, 2005

(54) Terminal layout structure of a two-layer electronic card connector

(76) Inventor: Ipson Lee, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/761,355

(22) Filed: Jan. 22, 2004

(51) Int. Cl. H01R 13/60

(52) U.S. Cl. 439/541.5

(57) ABSTRACT

A terminal layout structure of a two-layer electronic card connector, including a plastic main body. A front end face of the plastic main body is formed with a first insertion socket and a second insertion socket parallel to each other. Multiple upper and lower terminals are side by side inserted in the first and second insertion sockets. The rear end face of the plastic main body is formed with a rear terminal stem receptacle corresponding to the upper terminal cavities of the first insertion socket. The upper terminals are accommodated in the rear terminal stem receptacle. The front end face of the plastic main body is formed with a front terminal stem receptacle corresponding to the lower terminal cavities of the second insertion socket. The lower terminals are accommodated in the front terminal stem receptacle.

### BACKGROUND OF THE INVENTION

1. Field of the Invention

The present invention is related to a terminal layout structure of a conventional two-layer electronic card connector. The upper and lower terminals aligned with each other in the same row are effectively separated by the plastic main body, whereby the upper and lower terminals are prevented from being too close to each other and thus the problem of signal interference or even short circuit can be avoided.

2. Description of the Prior Art

FIGS. 12 and 13 show an existent two-layer electronic card connector applied to double electronic cards. The electronic card connector includes a plastic main body 17. The front end face of the main body 17 is formed with a first insertion socket 171 and a second insertion socket 172 parallel to each other. Multiple upper terminal cavities 1711 are side by side arranged in the first insertion socket 171. Multiple lower terminal cavities 1721 are side by side arranged in the second insertion socket 172. The lower terminal cavities 1721 respectively projectively correspond to the upper terminal cavities 1711. The first sections 181 of multiple upper terminals 18 extend into the upper terminal cavities 1711 of the first insertion socket 171. The bottom ends 1820 of the second sections 182 of the upper terminals 18 are connected on a circuit board. The first sections 191 of multiple lower terminals 19 extend into the lower terminal cavities 1721 of the second insertion socket 172. The bottom ends 1920 of the second sections 192 of the lower terminals 19 are connected on the circuit board. The upper and lower terminals 18, 19 are projectively aligned with each other in the same row. The second sections 182, 192 of the upper and lower terminals 18, 19 are respectively connected with different contacts of the circuit board. The rear end face of the plastic main body 17 is formed with a rear terminal stem receptacle 170 corresponding to the upper and lower terminal cavities 1711, 1721. The second sections 182, 192 of the upper and lower terminals 18, 19 are accommodated in the rear terminal stem receptacle 170.

In the above structure, the second sections 182, 192 of the upper and lower terminals 18, 19 are closely accommodated in the same rear terminal stem receptacle 170 without insulation. Therefore, interference or short circuit often takes place.

### SUMMARY OF THE INVENTION

It is therefore a primary object of the present invention to provide a terminal layout structure of a two-layer electronic card connector, including: a plastic main body, a front end face of the plastic main body being formed with a first insertion socket and a second insertion socket parallel to each other, multiple upper terminal cavities being side by side arranged in the first insertion socket, multiple lower terminal cavities being side by side arranged in the second insertion socket, the lower terminal cavities respectively projectively corresponding to the upper terminal cavities; multiple upper terminals, first sections of the upper terminals extending in the upper terminal cavities of the first insertion socket, bottom ends of second sections of the upper terminals being connected on a circuit board; and multiple lower terminals, first sections of the lower terminals extending in the lower terminal cavities of the second insertion socket, bottom ends of second sections of the lower terminals being connected on the circuit board. In the case that the second sections of the upper and lower terminals projectively aligned with each other in the same row are respectively connected with different contacts of the circuit board, the rear end face of the plastic main body is formed with a rear terminal stem receptacle corresponding to the upper terminal cavities of the first insertion socket. The second sections of the upper terminals are inserted in the rear terminal stem receptacle. The front end face of the plastic main body is formed with a front terminal stem receptacle corresponding to the lower terminal cavities of the second insertion socket. The second sections of the lower terminals are inserted in the front terminal stem receptacle. The second sections of the upper and lower terminals are separated by the plastic main body, whereby the second sections of the upper and lower terminals are prevented from being too close to each other and thus the problem of signal interference or even short circuit can be avoided.

The present invention can be best understood through the following description and accompanying drawings wherein:

### BRIEF DESCRIPTION OF THE DRAWINGS

FIG. 1 is a top view showing the structure of the present invention;

FIG. 2 is a front view showing the structure of the present invention;

FIG. 3 is a rear view showing the structure of the present invention;

FIG. 4 is a sectional view taken along line 4-4 of FIG. 1;

FIG. 5 is a sectional view taken along line 5-5 of FIG. 1;

FIG. 6 is a sectional view taken along line 6-6 of FIG. 1;

FIG. 7 is a sectional view taken along line 7-7 of FIG. 1;

FIG. 8 is a sectional view taken along line 8-8 of FIG. 1;

FIG. 9 is a sectional view taken along line 9-9 of FIG. 1;

FIG. 10 is a sectional view taken along line 10-10 of FIG. 1;

FIG. 11 is a sectional view taken along line 11-11 of FIG. 1;

FIG. 12 is a top view showing the structure of a conventional two-layer electronic card connector; and

FIG. 13 is a sectional view taken along line 13-13 of FIG. 12.

### DETAILED DESCRIPTION OF THE PREFERRED EMBODIMENTS

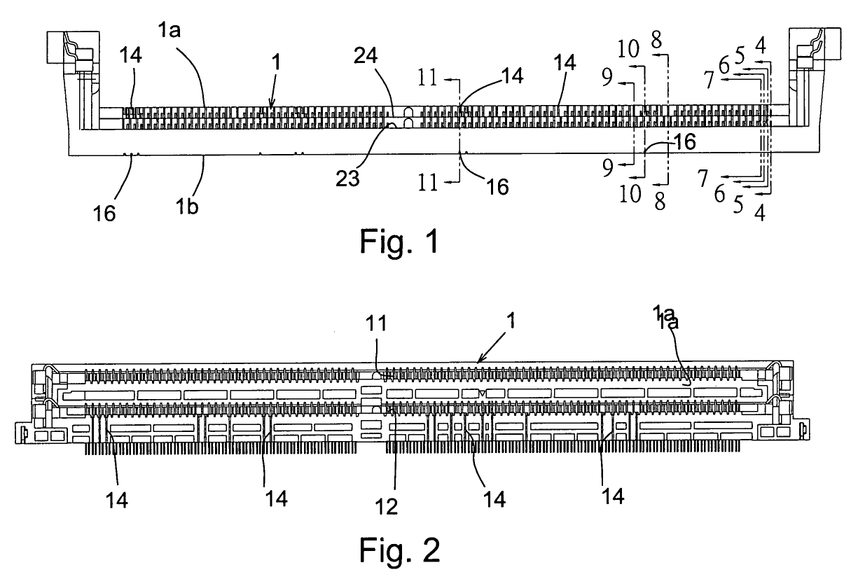

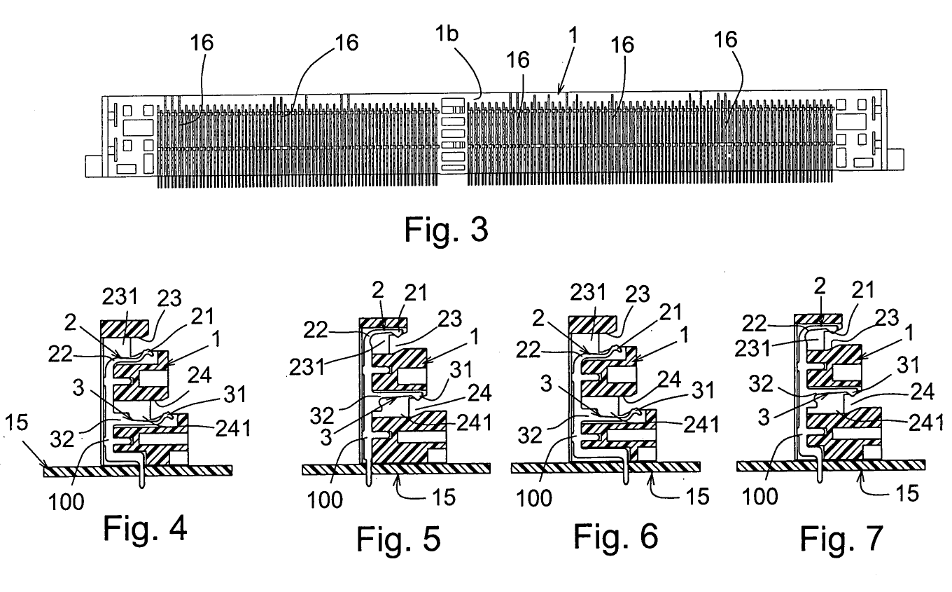

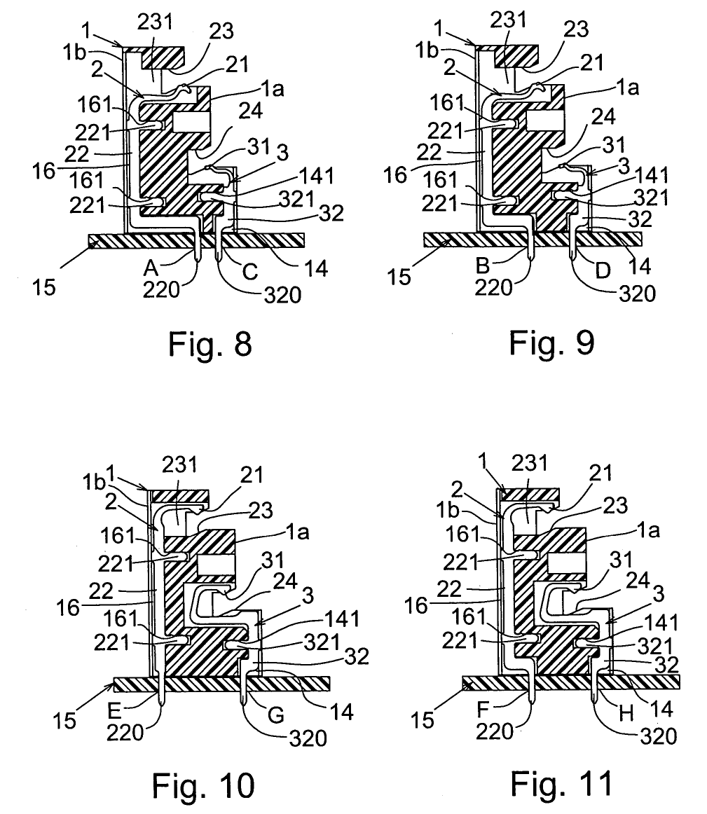

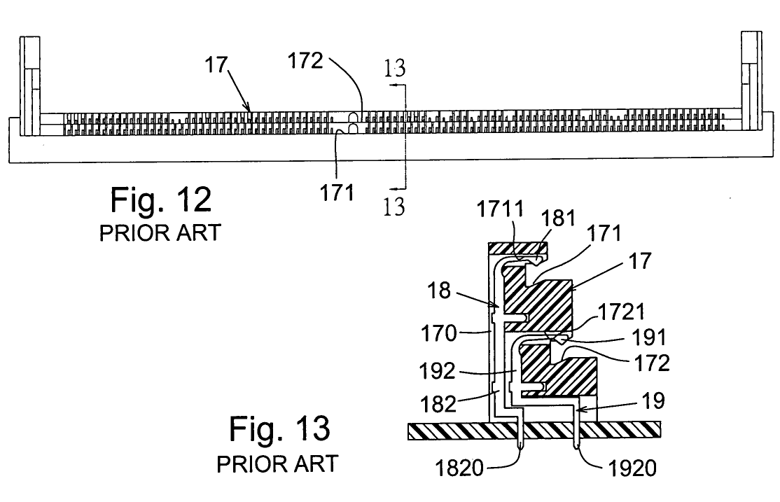

Please refer to FIGS. 1 to 11. The two-layer electronic card connector of the present invention includes a plastic main body 1. A front end face 1a of the main body 1 is formed with a first insertion socket 23 and a second insertion socket 24 parallel to each other. Multiple upper terminal cavities 231 are side by side arranged in the first insertion socket 23. Multiple lower terminal cavities 241 are side by side arranged in the second insertion socket 24. The lower terminal cavities 241 respectively projectively correspond to the upper terminal cavities 231. The first sections 21 of multiple upper terminals 2 extend into the upper terminal cavities 231 of the first insertion socket 23. The bottom ends 220 of the second sections 22 of the upper terminals 2 are connected on a circuit board 15. The first sections 31 of multiple lower terminals 3 extend into the lower terminal cavities 241 of the second insertion socket 24. The bottom ends 320 of the second sections 32 of the lower terminals 3 are connected on the circuit board 15.

In the case that the second sections 22, 32 of the upper and lower terminals 2, 3 projectively aligned with each other in the same row are respectively connected with different contacts of the circuit board 15, the rear end face 1b of the plastic main body 1 is formed with a rear terminal stem receptacle 16 corresponding to the upper terminal cavities 231 of the first insertion socket 23. The second sections 22 of the upper terminals 2 are accommodated in the rear terminal stem receptacle 16. In addition, the front end face 1a of the plastic main body 1 is formed with a front terminal stem receptacle 14 corresponding to the lower terminal cavities 241 of the second insertion socket 24. The second sections 32 of the lower terminals 3 are accommodated in the front terminal stem receptacle 14. Accordingly, the second sections 22, 32 of the upper and lower terminals 2, 3 are separated by the plastic main body 1, whereby the second sections 22, 32 of the upper and lower terminals 2, 3 are prevented from being too close to each other and thus the problem of signal interference or even short circuit can be avoided.

According to standard specification design, the upper and lower terminals 2, 3 are inlaid in the plastic main body 1 and connected with the contacts of the inserted electronic card and the contacts of the circuit board 15 in different positions. For example, as shown in FIGS. 4 to 7, the first sections 21, 31 of the upper and lower terminals 2, 3 in the same row respectively resiliently correspondingly extend in upper or lower sides of the upper and lower terminal cavities 231, 241 of the plastic main body 1. The second sections 22, 32 of the upper and lower terminals 2, 3 are integrally connected with a conductive plate 100 and extend therefrom. By means of the conductive plate 100, the upper and lower terminals 2, 3 are connected with the same contact of the circuit board 15. The arrangement and configuration of the above upper and lower terminals 2, 3 pertain to prior art and will not be further described hereinafter.

Referring to FIGS. 1, 2, 3, 8 and 9, the terminal layout structure of the present invention is characterized in that the first section 21 of the upper terminal 2 resiliently extends in the lower side of the upper terminal cavity 231 of the plastic main body 1 for connecting with a bottom contact of the inserted electronic card. The second section 22 downward windingly extends from the rear end of the first section 21 into the rear terminal stem receptacle 16 of the rear end face 1b of the plastic main body 1. At least one insertion plate 221 horizontally projects from one side of the second section 22 for correspondingly inserting into an insertion cave 161 formed on inner side of the rear terminal stem receptacle 16. The bottom end 220 of the second section 22 of the upper terminal 2 is connected with a first contact A (or second contact B as shown in FIG. 9) of the circuit board 15. The first section 31 of the lower terminal 3 resiliently extends from the front end face 1a of the plastic main body 1 into the lower side of the lower terminal cavity 241 for connecting with a bottom contact of the inserted electronic card. The second section 32 downward windingly extends from the front end of the first section 31 into the front terminal stem receptacle 14 of the front end face 1a of the plastic main body 1. At least one insertion plate 321 horizontally projects from one side of the second section 32 for correspondingly inserting into an insertion cave 141 formed on inner side of the front terminal stem receptacle 14. The bottom end 320 of the second section 32 of the lower terminal 3 is connected with a third contact C (or fourth contact D as shown in FIG. 9) of the circuit board 15.

Alternatively, referring to FIGS. 1, 2, 3, 10 and 11, the first section 21 of the upper terminal 2 resiliently extends in the upper side of the upper terminal cavity 231 of the plastic main body 1 for connecting with a top contact of the inserted electronic card. The second section 22 downward windingly extends from the rear end of the first section 21 into the rear terminal stem receptacle 16 of the rear end face 1b of the plastic main body 1. At least one insertion plate 221 horizontally projects from one side of the second section 22 for correspondingly inserting into an insertion cave 161 formed on inner side of the rear terminal stem receptacle 16. The bottom end 220 of the second section 22 of the upper terminal 2 is connected with a fifth contact E (or sixth contact F as shown in FIG. 11) of the circuit board 15. The first section 31 of the lower terminal 3 is substantially C-shaped and inward resiliently extends from the front end face 1a of the plastic main body 1 into the lower terminal cavity 241. The free end of the first section of the lower terminal 3 is positioned on upper side of the lower terminal cavity 241 for connecting with a top contact of the inserted electronic card. The second section 32 downward windingly extends from the front end of the first section 31 into the front terminal stem receptacle 14 of the front end face 1a of the plastic main body 1. At least one insertion plate 321 horizontally projects from one side of the second section 32 for correspondingly inserting into an insertion cave 141 formed on inner side of the front terminal stem receptacle 14. The bottom end 320 of the second section 32 of the lower terminal 3 is connected with a seventh contact G (or eighth contact H as shown in FIG. 11) of the circuit board 15.

In the above structure, when the second sections 22, 32 of the upper and lower terminals 2, 3 in the same row are respectively connected with different contacts of the circuit board 15, the upper terminal 2 is inserted into the plastic main body 1 from the rear end face 1b of the plastic main body 1, while the lower terminal 3 is inserted into the plastic main body 1 from the front end face 1a of the plastic main body 1. Therefore, the second sections 22, 32 of the upper and lower terminals 2, 3 are separated by the plastic main body 1, whereby the second sections 22, 32 of the upper and lower terminals 2, 3 are prevented from being too close to each other and thus the problem of signal interference or even short circuit can be avoided.

The above embodiments are only used to illustrate the present invention, not intended to limit the scope thereof. Many modifications of the above embodiments can be made without departing from the spirit of the present invention.

1. A terminal layout structure of a two-layer electronic card connector, comprising:
(a) a plastic main body, a front end face of the plastic main body being formed with a first insertion socket and a second insertion socket parallel to each other, multiple upper terminal cavities being side by side arranged in the first insertion socket, multiple lower terminal cavities being side by side arranged in the second insertion socket, the lower terminal cavities respectively projectively corresponding to the upper terminal cavities;
(b) multiple upper terminals, first sections of the upper terminals extending in the upper terminal cavities of the first insertion socket, bottom ends of second sections of the upper terminals being connected on a circuit board; and
(c) multiple lower terminals, first sections of the lower terminals extending in the lower terminal cavities of the second insertion socket, bottom ends of second sections of the lower terminals being connected on the circuit board, in the case that the second sections of the upper and lower terminals projectively aligned with each other in the same row are respectively connected with different contacts of the circuit board, the rear end face of the plastic main body being formed with a rear terminal stem receptacle corresponding to the upper terminal cavities of the first insertion socket, the second sections of the upper terminals being inserted in the rear terminal stem receptacle, the front end face of the plastic main body being formed with a front terminal stem receptacle corresponding to the lower terminal cavities of the second insertion socket, the second sections of the lower terminals being inserted in the front terminal stem receptacle.

2. The terminal layout structure of a two-layer electronic card connector as claimed in claim 1, wherein the first section of the upper terminal resiliently extends in lower side of the upper terminal cavity of the plastic main body for connecting with a bottom contact of the inserted electronic card, the second section of the upper terminal downward windingly extending from the rear end of the first section into the rear terminal stem receptacle of the rear end face of the plastic main body, the bottom end of the second section of the upper terminal being connected on the circuit board.

3. The terminal layout structure of a two-layer electronic card connector as claimed in claim 2, wherein at least one insertion plate horizontally projects from one side of the second section of the upper terminal for correspondingly inserting into an insertion cave formed on inner side of the rear terminal stem receptacle.

4. The terminal layout structure of a two-layer electronic card connector as claimed in claim 1, wherein the first section of the lower terminal resiliently extends from the front end face of the plastic main body into the lower side of the lower terminal cavity for connecting with a bottom contact of the inserted electronic card, the second section of the lower terminal downward windingly extending from the front end of the first section into the front terminal stem receptacle of the front end face of the plastic main body, the bottom end of the second section of the lower terminal being connected on the circuit board.

5. The terminal layout structure of a two-layer electronic card connector as claimed in claim 4, wherein at least one insertion plate horizontally projects from one side of the second section of the lower terminal for correspondingly inserting into an insertion cave formed on inner side of the front terminal stem receptacle.

6. The terminal layout structure of a two-layer electronic card connector as claimed in claim 1, wherein the first section of the upper terminal resiliently extends in the upper side of the upper terminal cavity of the plastic main body for connecting with a top contact of the inserted electronic card, the second section of the upper terminal downward windingly extending from the rear end of the first section into the rear terminal stem receptacle of the rear end face of the plastic main body, the bottom end of the second section of the upper terminal being connected on the circuit board.

7. The terminal layout structure of a two-layer electronic card connector as claimed in claim 6, wherein at least one insertion plate horizontally projects from one side of the second section of the upper terminal for correspondingly inserting into an insertion cave formed on inner side of the rear terminal stem receptacle.

8. The terminal layout structure of a two-layer electronic card connector as claimed in claim 1, wherein the first section of the lower terminal is substantially C-shaped and inward resiliently extends from the front end face of the plastic main body into the lower terminal cavity, a free end of the first section of the lower terminal being positioned on upper side of the lower terminal cavity for connecting with a top contact of the inserted electronic card, the second section of the lower terminal downward windingly extending from the front end of the first section into the front terminal stem receptacle of the front end face of the plastic main body, the bottom end of the second section of the lower terminal being connected on the circuit board.

9. The terminal layout structure of a two-layer electronic card connector as claimed in claim 8, wherein at least one insertion plate horizontally projects from one side of the second section of the lower terminal for correspondingly inserting into an insertion cave formed on inner side of the front terminal stem receptacle.
